(19) United States
(12) Patent Application Publication
(10) Pub. No.: US 2002/0067662 A1
(43) Pub. Date: Jun. 6, 2002

(54) APPARATUS AND METHOD FOR THE MOUNTING, DEPLOYMENT AND USE OF HYDROGRAPHIC SURVEYING DEVICES

(76) Inventor: THOMAS CARNEY, PATCHOGUE, NY (US)

Correspondence Address: JASPAN SCHLESINGER HOFFMAN LLP, 300 GARDEN CITY PLAZA, GARDEN CITY, NY, 11530, US

(21) Appl. No.: 09/330,263

(22) Filed: Jun. 11, 1999

Related U.S. Application Data
(60) Provisional application No. 60/089,096, filed on Jun. 12, 1998.

(51) Int. Cl. H04R 1/00

(52) U.S. Cl. 367/173

(57) ABSTRACT

A vessel of generally conventional design is provided with a hydrographic survey apparatus in which the transducer of the survey apparatus is mounted on a boom swingable about a substantially horizontal axis between a deployed and stowed position. The boom is located in a slot aligned in a vertical plane along the boat's centerline and extends downward from the boat's top deck. The boom is mounted at one end near the bow of the boat by attachment to a drive shaft extending beam-wise or transversely across the slot. The drive shaft is operated by a hydraulic rotary actuator. The transducer is mounted on the free end of the boom and is swingable about the drive shaft into and out of the water. The transducer is thus selectively movable from a stowed position to a deployed position in front of the vessel where it is placed in still non-turbulent water, i.e.; water that is free from mechanical vibration and noise of the survey boat and aquatic turbulence from the hull.

The Applicant hereby claims priority of Provisional Application No. 60/089,096 filed Jun. 12, 1998.

### BACKGROUND OF THE INVENTION

The present invention relates to a hydrographic survey apparatus and survey vessel for mapping and surveying the bottom of an ocean, lake or waterway.

In the past marine surveyors employed transducers placed in the water alongside or behind a vessel. The transducers direct a number of streams of energy, such as sonar or other pulsed energy toward the bottom of the water while the bottom is traversed by the vessel. The transducer receives reflected signals from the water bottom, and produces a raw signal that can be translated into processed survey data producing a map of the water bottom, and or the contents of the water. Sometimes such equipment is augmented with a global positioning satellite (GPS) navigation aid to provide the transducer with the accurate data.

Until now the transducer has been hung over the side of a survey vessel or behind the boat in order to troll it through the water. This results in the disadvantage that the transducer is subjected to noise from the boat's engine and the turbulent movement of water around and against the hull of the boat. Since the transducer may be using a sonar arrangement involving emission and reception of sounds as the essential measuring tool, undesirable noise interference compromises the ability of the transducer to produce a clear and useable signal.

In addition to the foregoing, survey devices of the type found in the prior art are rather large complex devices that are not easily deployed or stowed. Consequently, these devices, and the vessels with which they are used, can not be easily moved from site to site. Certainly, trailering the vessel together with the survey device is not a viable option. This prevents the use of the vessel and survey device on inland lakes and waterways as they can not be transported to the site.

It is therefore an object of the present invention to provide an improved survey apparatus that overcomes the shortcomings found in the prior art devices.

It is another object of the present invention to provide a survey apparats that positions transducer so that it is placed in still non-turbulent water, i.e.; water that is free from mechanical vibration and noise of the survey boat and aquatic turbulence from the hull.

It is yet another object of the present invention to provide a survey vessel having a mechanically deployable transducer.

It is a further object of the present invention to provide a hydrographic survey apparatus that is simple and compact in construction enabling the maritime survey apparatus and survey vessel to be trailered from site to site.

The foregoing objects and advantages as well as others will be apparent from the following disclosure of the present invention.

### SUMMARY OF THE INVENTION

In accordance with the present invention, a vessel of generally conventional design is provided with a hydrographic survey apparatus in which the transducer of the survey apparatus is mounted on a boom swingable about a substantially horizontal axis between a deployed and stowed position.

The boom is located in a slot aligned in a vertical plane along the boat's centerline and extends downward from the boat's top deck. The boom is mounted at one end near the bow of the boat by attachment to a drive shaft extending beam-wise or transversely across the slot. The drive shaft is operated by a hydraulic rotary actuator. The transducer is mounted on the free end of the boom and is swingable about the drive shaft into and out of the water. The transducer is thus selectively movable from a stowed position to a deployed position in front of the vessel where it is placed in still non-turbulent water, i.e.; water that is free from mechanical vibration and noise of the survey boat and aquatic turbulence from the hull.

To facilitate movement of the transducer, the front or prow of the vessel may be cut back to form a straight or barge like prow. In another embodiment, the boom may be simply mounted upon the main forward deck of the vessel such that the vessel's hull does not have to be modified to form a slot.

Full details of the present invention are described in the following description and illustrated in the accompanying drawings.

### BRIEF DESCRIPTION OF THE DRAWING

In the drawings:

FIG. 1 is a front perspective view of the survey vessel and hydrographic survey apparatus according to the present invention;

FIG. 2 is a perspective view of the survey vessel depicted in FIG. 1 showing an exploded view of the hydrographic survey apparatus;

FIG. 3 is a side elevational view of the survey vessel showing the hydrographic survey apparatus in the stowed position;

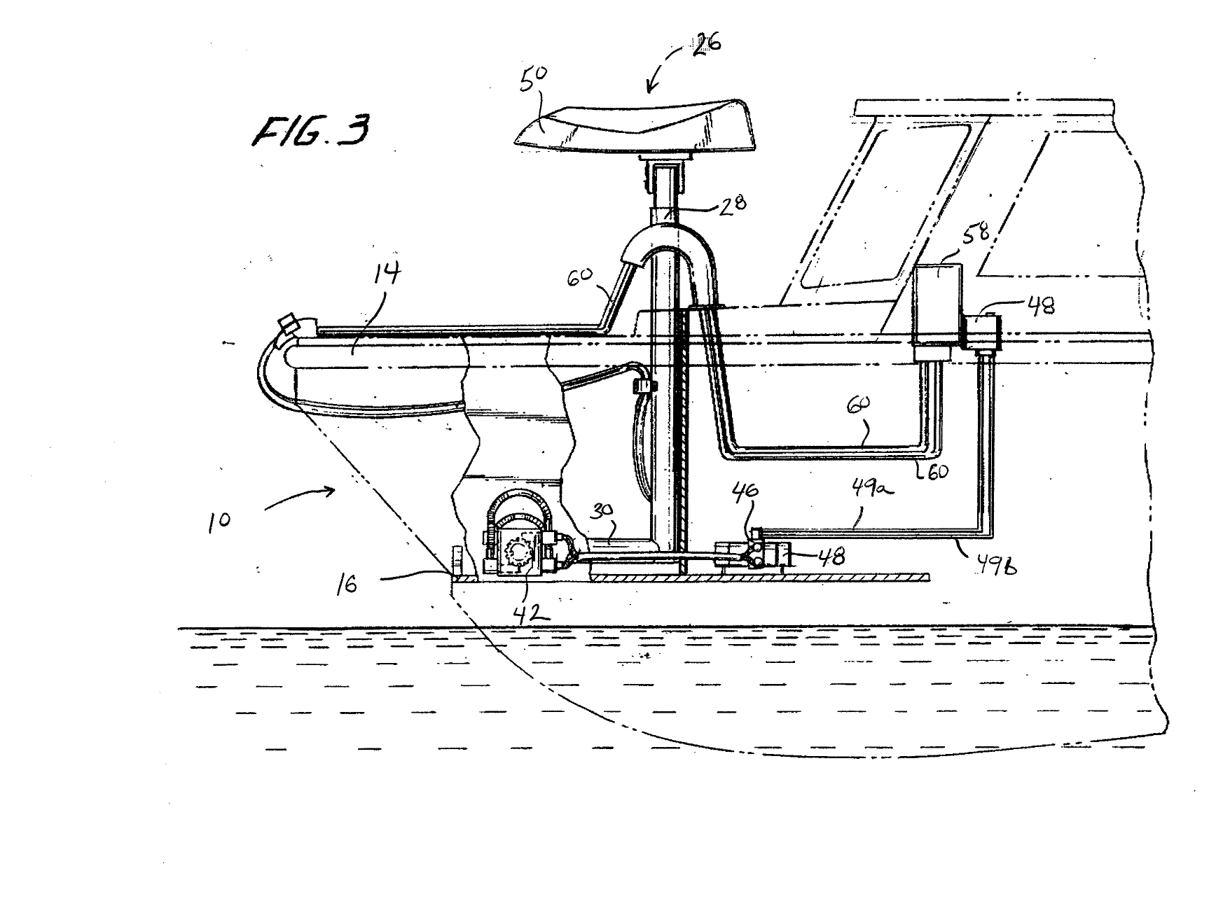

FIG. 4 is a side elevational view of the survey vessel showing the hydrographic survey apparatus in the deployed position;

FIG. 5 is a front perspective view an alternative embodiment of the hydrographic survey apparatus according to the present invention;

### DETAILED DESCRIPTION OF THE PREFERRED EMBODIMENT

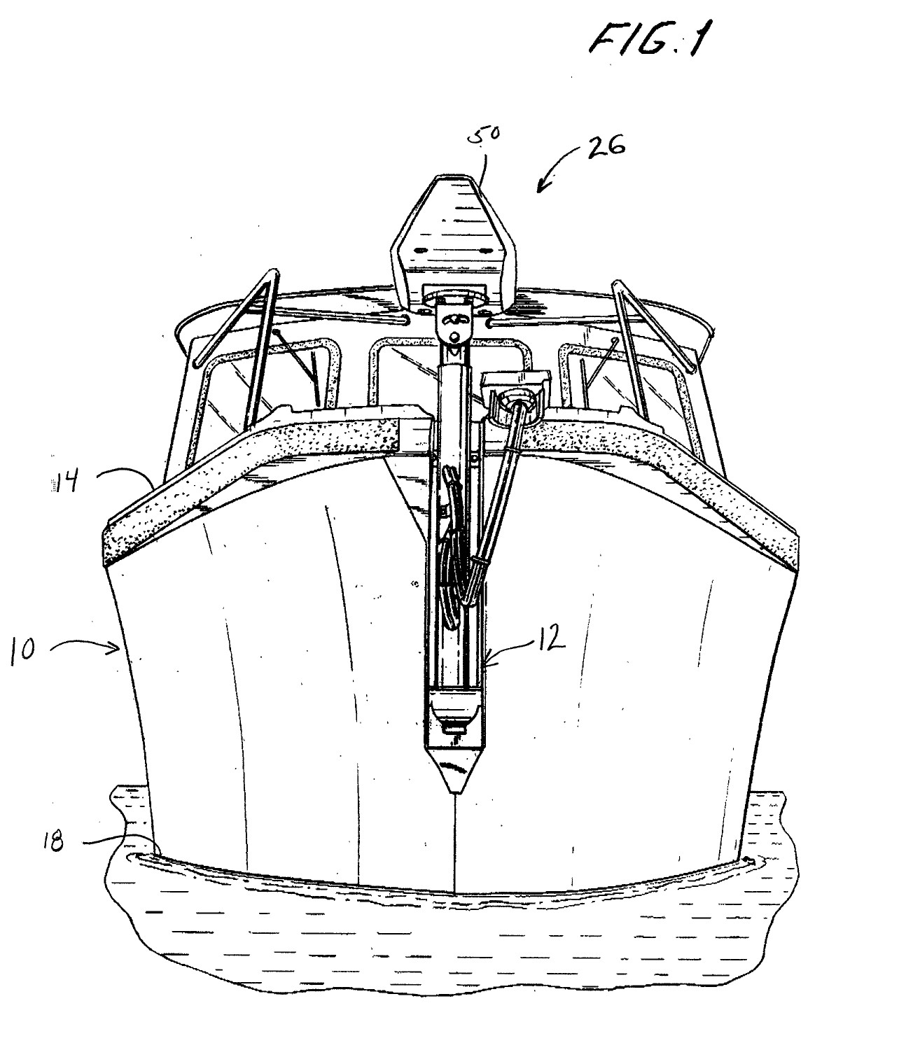

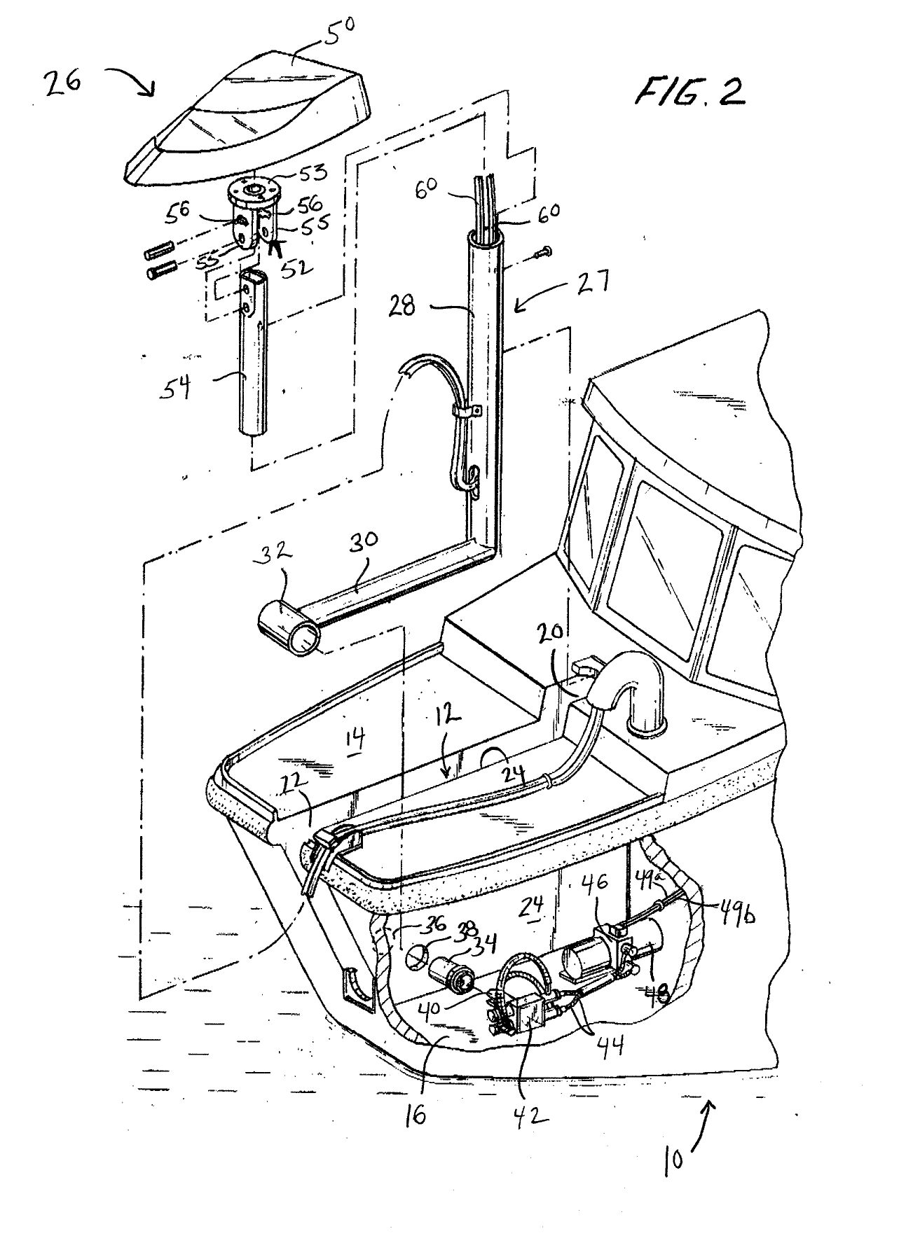

As seen in FIGS. 1 and 2, a survey vessel generally depicted by the numeral 10, is provide with a slot 12 extending vertically from the top deck 14 downwardly and terminating at the main deck 16, well above the normal high waterline 18. The slot 12 extends rearwardly from the prow along the vertical central plane of the boat and terminates in aft, starboard and port bulkheads, 20, 22 and 24 respectively. The bulkheads are sealed to each other and to the main deck 16 by welding, caulking or the like so as to maintain the integrity of the slot and the boat water tight. It preferable that the survey vessel 10 be approximately twenty to approximately forty-five feet in length so as to permit the easy trailering of the vessel from one survey site to another. Of course, it will be appreciated that the survey apparatus as disclosed herein may be used or adapted for use with any sized vessel.

Located within the slot 12 is a hydrographic survey apparatus generally depicted by the numeral 26. The survey apparatus 26 comprises an L-shaped boom 27 having a long leg 28 and a short leg 30. Secured at the end of the short leg is a cylindrical stub shaft 32 which is mounted to a bushing 34. The bushing 34 passes through apertures 36 and 38 in the starboard and port bulkheads and is journaled at each end to bearing means enabling the bushing to rotate. The bearing means comprises DELREN Bulkhead Bearings contained interiorly of the hull behind the starboard and port bulkheads 22 and 24. The bushing 34 is provided with seal means sealing both the apertures 36 and 38 against entry of water making the vertical slot watertight. The bushing 34 fits around and is secured to a drive shaft 40 of a double acting hydraulic rotary actuator 42. The rotary actuator 42 is of the type that includes a linear two way piston and gearing to translate the linear motion of the piston into rotary movement of the drive shaft 40. The rotary actuator 42 may be one of the H-Series Rotary Actuators, Models H6 through H133 manufactured by OHIO OSCILLATOR, INC.

The rotary actuator 42 is operably connected by a pair of hoses 44 to a valve device 46. The valve device 46 permits the operator of the vessel to control the flow of the hydraulic fluid from a hydraulic pump 48 into the hydraulic rotary actuator 42. The operation of the hydraulic pump 48 via the valve device 46 controls the flow of liquid into and out of the rotary actuator 42, thereby controlling the linear motion of the piston which is translated into the rotational movement of the drive shaft 40.

The hydraulic pump 48 and valve device 46 are electronically connected to a power supply and control unit 48 contained in the pilot house of the vessel by electronic leads 49a and 49b, respectively. In this manner, the operator of the vessel can selectively control the operation of valve device 46 via the control unit 48 thereby controlling the operation of the hydraulic pump 48, rotary actuator and 42 and ultimately the drive shaft 40.

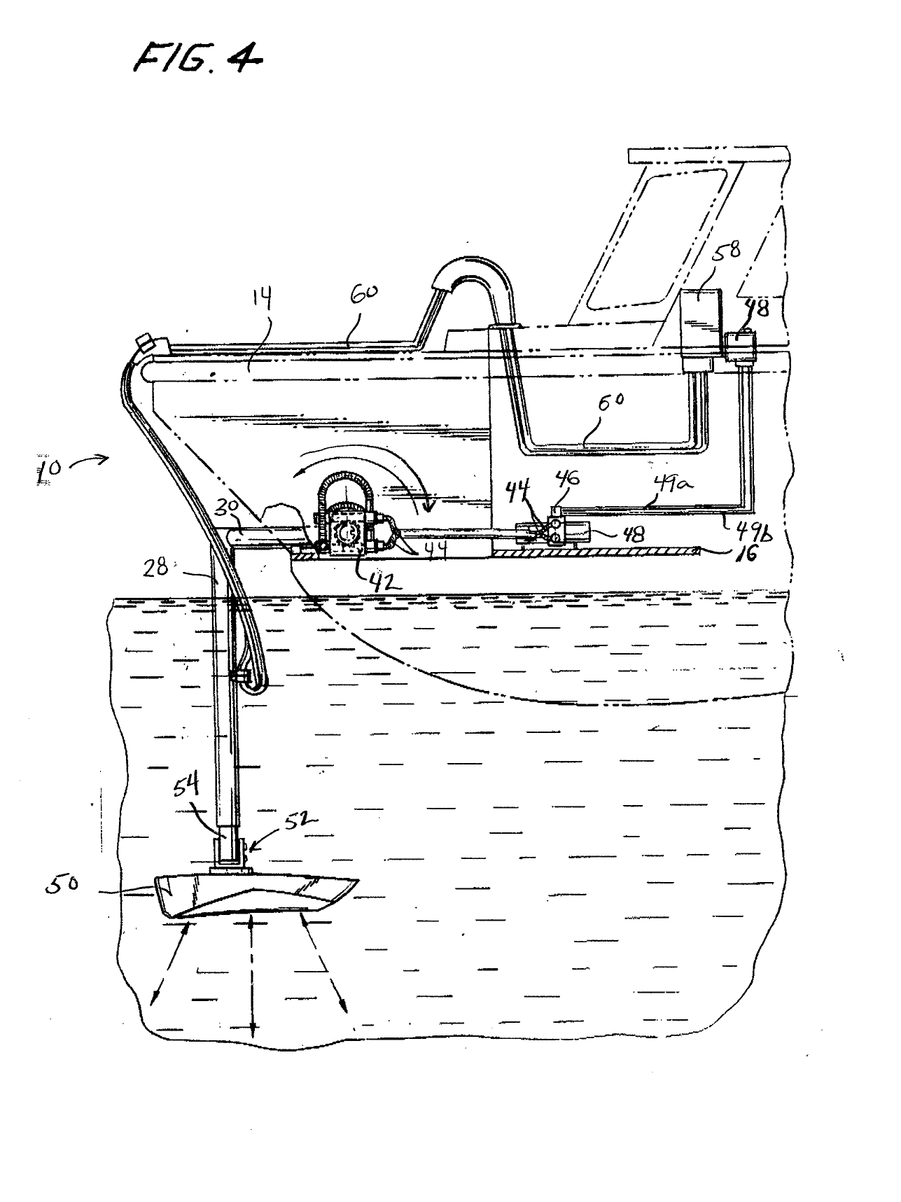

Operation of the of the rotary actuator 42 will cause the drive shaft 40 to rotate about its center, thereby causing the boom 27 to swing through an arc of approximately 180 degrees, about the axis of the drive shaft 40. The operator, via the control unit 48, can selectively control the rotation of the drive shaft 40 to rotate either in the counterclockwise or clockwise directions. In this manner, the boom 27 can be alternated between a first stowed position wherein the long leg 28 is oriented vertically upward and a second deployed position wherein the long leg 28 extends vertically downward in front of the vessel as best seen in FIG. 4.

While the boom 27 is shown here as simply L-shaped, it will be understood that this shape may be altered or modified provided the boom allows the transducer to fully move between the stowed and deployed positions, permits freedom of movement on the deck and does not obstruct sight lines. Mounted at the end of the long leg 28 of boom 27 is a pod 50 which holds a transducer capable of conducting underwater hydrographic surveys. The pod 50 is mounted to the boom 27 by a bracket 52 which is secured to a first end of a mounting shaft 54. A second end of the mounting shaft 54 is inserted within the boom 27 and the mounting shaft is fixedly secured therein.

The bracket 52 includes a planar surface 53 on which the pod 50 sits and two spaced flanges 55 that extend vertically from the planar surface 53. When the bracket 52 is secured to the mounting shaft 54, each flange extends along an opposite side of the mounting shaft 54 as shown in FIG. 2.

Each flange 55 is provided with a curved throughslot 56 thorough which is inserted one of the mounting bolts. The curved throughslot 56 permits the bracket 52 to be secured to the mounting shaft 54 in an angled or tilted fashion. This enables the operator to manually adjust the angular tilt of the pod 50 and the transducer contained therein. By selectively adjusting the tilt of the transducer, the operator can position the transducer so that it emits signals under and around piers, other vessels or other solid structures such as rock formations or the like. In this manner, the operator can obtain complete and accurate survey information of the geological structure of the survey site.

The transducer contained within the pod 50 comprises a radar or sonic sensing system, in which one or more radio or sonic wave beams are broadcast into the water and their echo is received and converted into an electrical signal indicative of the shape and distance of the object causing the echo.

Preferably, the transducer is one of the conventional multi beam transducer systems manufactured by the ODOM HYDROGRAPHIC, SYSTEMS, INC. However, other transducer systems other than those manufactured by ODOM may also be used.

To facilitate the easy swinging of the boom 27 and to insure that sufficient space is provided for the pod 50 as it passes in front of the prow, it may be desirable to cut-back the prow of the vessel, reducing its sharp pointed configuration, to provide a flat, barge like appearance at least above the water line. The size and configuration of the prow of the boat is not critical and will of course be determined in connection with the configuration and length of the boom, the position at which the boom is mounted to the drive shaft, and the position at which the rotary actuator is mounted to the main deck.

The vessel 10 will be provided with various equipment and systems to carry out its function as a hydrographic survey vessel. For example, the transducer operating system will include a data processor 58 for operating the transducer, itself and for processing the raw data; recorder devices to record the data both as a visual display as well as written graph. As shown the data processor 58 is electronically connected to the transducer via a plurality of electronic leads 60. The electronic leads 60 power the transducer and permit the transmission of data to and from the data processor 58.

The equipment may also be associated with a Global Positioning Satellite Navigation System (GPS) to record and track accurately the position of the vessel with regard to its survey. Such equipment may be housed below deck or in the pilot house for easy access.

In normal non-operating conditions, the boom is held in its upright first position. When the vessel reaches the area to be surveyed, the rotary actuator 42 is initiated and the boom 27 swings 180 degrees lowering the pod 50 into the water below and forward of the vessel itself. In this position, the pod 50 rests in relatively still and clean water (i.e. water free of turbulence caused by vibration and movement of the vessel, its wake and engine froth).

It should be appreciated that other means may be utilized to effectuate the rotary motion of the boom actuator 42. For example, an pneumatic system may be utilized or a two way electric motor may also be used. It will be apparent to those skilled in the art that numerous other means may also be utilized to effectuate the rotary action of the actuator and are within the scope of the present invention.

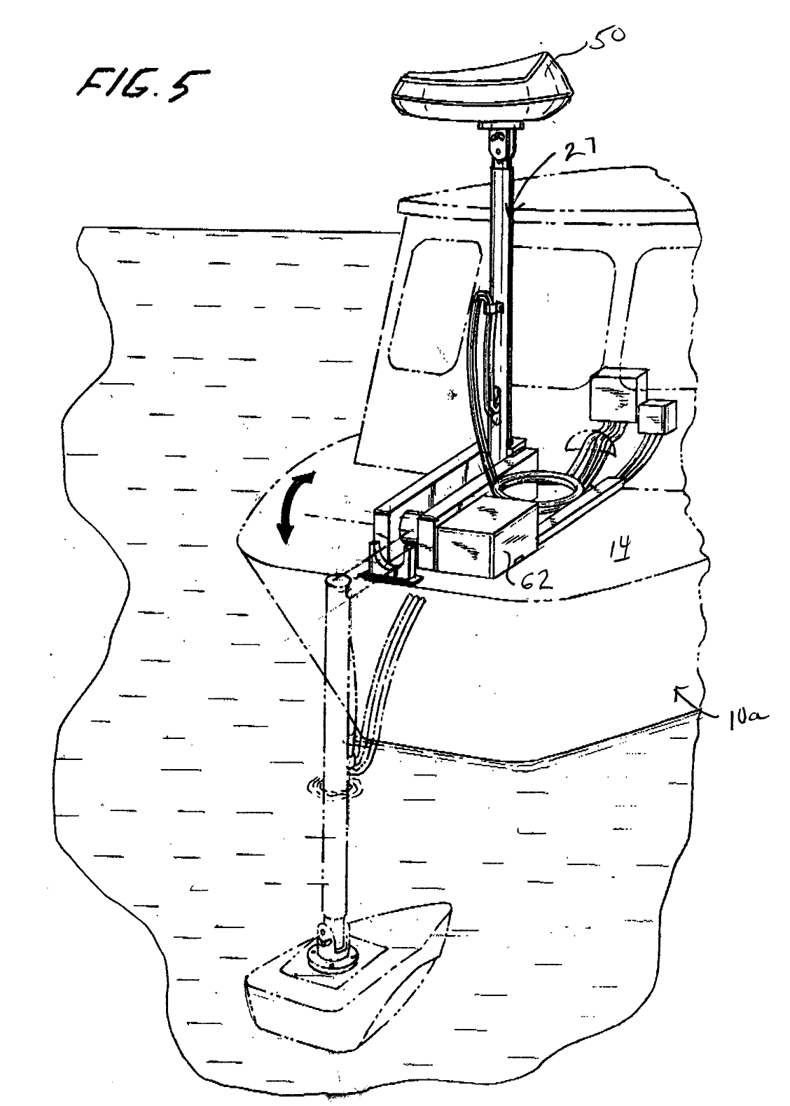

FIG. 5 depicts an alternative embodiment of the hydrographic survey apparatus according to the present inventions. In FIG. 5, the L-shaped boom 27 is mounted on the top deck 14 of a conventional vessel 10a which has not been modified and which maintains a cutter like prow. The rotary actuator 42 (not shown) is contained within a protective cowling 62 to maintain the rotary actuator clean and dry.

Because survey vessel 10a has no bow slot, the boom must be affixed to the main deck sufficiently close to the bow to permit the short leg 30 to project clear beyond the bow in the deployed position allowing the long arm to fully enter the water.

It is apparent that the boom and hydraulic actuator, transducer may be mounted on any type of boat hull and still perform the function according to the present method.

In order to conduct a survey session, the operator sails to the area to be surveyed while the boom is maintained in its upward or first position. Suitable lashing or ties can be used, preventing vibration of the boom relative to the vessel.

Once the vessel reaches the survey site the operator deploys and activates the transducer causing the transmission of energy signals in and through the water, the transducer receiving in return the reflected signals. The received signals are transmitted by cable extending from the transducer to the data processor where they are converted into data capable of visual display or recording, as a map of the sea or water. An input from a global positioning satellite (GPS) navigation can be included via the processor so that exact geographic coordinates can continually be matched with incoming data to provide complete and useful hydrographic survey results. To this end the alignment of the transducer and boom with the centerline of the boat allows for a more accurate cooperation between the transducer and the GPS navigation system eliminating the need for adjustments to make the GPS register with the transducer. Since the data streams of both systems depend on the exact position of the receiving equipment, i.e., the transducer for the bottom-mapping data and the GPS antenna for the geographic coordinates to be matched to the bottom-mapping data; such automatic registration eliminates a great deal of operation difficulty.

At the end of a survey session, the operator reverses the hydraulic actuator bringing the transducer out of the water restoring the boom to is upright stored position.

An important advantage of deploying the transducer at the front of the vessel lies in the fact that the transducer will move through the water in clean or still water, free from any extraneous noises and vibrations produced by the vessel itself as well as any extraneous noise and vibration of aquatic turbulence which might come from water striking the hull of the boat or wave disturbances or a wake resulting from the boat's motion. Thus a more reliable and stronger signal can be produced for processing.

An additional advantage of the present invention is that it permits the survey vessel operator to quickly and conveniently mechanically deploy and stow the transducer from below deck within the pilot house. There is no need for the operator to go on deck to operate or attend to the transducer. Thus the number of men required to operate the survey apparatus is minimized and the operability of the survey vessel in times of cold and inclement weather is possible.

The foregoing description of the present invention has been presented for purposes of illustration and description. It is not intended to be exhaustive or to limit the invention to the precise form described. Obvious modifications or variations are possible in light of the teachings without departing from the scope of the present invention.

In the claims:

1. In a hydrographic survey system employing a vessel and a transducer deployed from said vessel into a body of water to emit a signal and receive a reflected signal indicative of the contour of the surface below the water, the improvement comprising mounting the transducer at one end of a substantially rigid boom, and means for mounting the boom at its other end at the prow of said vessel so that said boom is operative to swing said transducer within substantially vertical plane from a first stowed position above the vessel to a second deployed position in front of said vessel and within said body of water.

2. The apparatus according to claim 1, wherein said vertical plane lies parallel to the central longitudinal axis of said vessel.

3. The apparatus according to claim 2, wherein the keel of said vessel lies within said vertical plane.

4. The apparatus according to claim 1, wherein said vessel is provided with a slot extending rearwardly from the from along a vertical central plane of the boat.

5. The apparatus according to claim 4, wherein said slot terminates in a plurality of bulkheads so as to maintain the integrity of the slot and the boat water tight.

6. The apparatus according to claim 1, wherein said vessel is approximately twenty to approximately forty-five feet in length.

7. The apparatus according to claim 1, wherein said means for mounting said boom includes means for rotating said boom from said first stowed position to said second deployed position.

8. The apparatus according to claim 7, wherein said means for rotating said boom comprises a hydraulic rotary actuator.

9. The apparatus according to claim 8, further comprising a hydraulic pump operably connected to said rotary actuator for supplying a hydraulic fluid to said rotary actuator.

10. The apparatus according to claim 9, further comprising a valve device for selectively controlling the flow of said hydraulic from said hydraulic pump to said rotary actuator.

11. The apparatus according to claim 10, further comprising means for controlling the operation of said valve device.

12. The apparatus according to claim 1, wherein the angular tilt of said transducer relative to a horizontal plane may be selectively adjusted.
